(19) United States
(12) Patent Application Publication
(10) Pub. No.: US 2012/0099435 A1
(43) Pub. Date: Apr. 26, 2012

(54) ESTIMATING SPARSE MIMO CHANNELS HAVING COMMON SUPPORT

(75) Inventors: Yann Barbotin, Renens (CH); Ali Hormati, Renens (CH); Sundeep Rangan, Jersey City, NJ (US); Martin Vetterli, Grandvaux (CH)

(73) Assignee: QUALCOMM INCORPORATED, San Diego, CA (US)

(21) Appl. No.: 13/277,124

(22) Filed: Oct. 19, 2011

Related U.S. Application Data
(60) Provisional application No. 61/405,123, filed on Oct. 20, 2010.

(51) Int. Cl. H04L 12/26

(52) U.S. Cl. 370/241

(57) ABSTRACT

According to a first aspect of the present invention there is provided a method of estimating, jointly, a set of multipath channels having a common path support, the method comprising the steps of, estimating jointly the common path support of the set of multipath channels using a spectral estimation technique, estimating path amplitudes, for each channel in the set of multipath channels, using the estimation of the common path support, to obtain an estimate of the set of multipath channels.

### RELATED APPLICATIONS

This application claims the benefit of U.S. Provisional Application No. 61/405,123 filed on 20 Oct. 2010, which is hereby incorporated by reference in its entirety.

### TECHNICAL FIELD

The present disclosure relates to system a method of estimating, jointly, a set of multipath channels having a common path support. The system and method may be applied to multiple output systems such as MIMO (multiple input multiple output) or SIMO (single input multiple output) communications.

### BACKGROUND

Multiple transmit-receive antennas can be used for either spatial diversity or spatial multiplexing. Generally, to estimate the multiple channels over which the multiple transmit-receive antennas communicate, separate channel estimates for each transmit-receive antenna pair is required. Existing receivers estimate each of multiple channels separately; thus the process of estimation of the multiple channels leads to large pilot overhead. Furthermore, as each of the multiple channels is estimated separately, there is more scope of errors to occur in the estimations.

It is an aim of the present invention to obviate or mitigate at least some of the afore-mentioned disadvantages.

### SUMMARY

According to a first aspect of the present invention there is provided a method of estimating, jointly, a set of multipath channels having a common path support, the method comprising the steps of,
estimating jointly the common path support of the set of multipath channels using a spectral estimation technique,
estimating path amplitudes, for each channel in the set of multipath channels, using the estimation of the common path support, to obtain an estimate of the set of multipath channels.

Preferably, the method of the present invention uses a continuous time model of the multipath channels.

The estimated path amplitudes and the common paths support provide a full description of the multipath channels.

Preferably, the channels with sparse common support have a small number of paths (i.e. they are sparse) with the same time of arrival (ToA) across the different channels, up to a delay ±ε. The idealized case, ε=0, is referred to as an exact spare common support channel.

The common support assumption is physically relevant if the receiver's antennas are separated by a fraction of the distance an electromagnetic wave travels in a time corresponding to the inverse bandwidth of the channel. Under this assumption, the channels' supports differ only by a quantity ε unresolvable in practical operating conditions.

Using a sparse common support model, the total number of parameters to be estimated can be reduced, thereby improving the estimate and/or reducing the pilot overhead.

The step of estimating path amplitudes may comprise the step of estimating path amplitudes, for each channel in the set of multipath channels, separately, using the estimation of the common path support.

The step of estimating path amplitudes, for each channel in the set of multipath channels, using the estimation of the common path support, may comprise the step of solving a linear system of equations. The linear system of equations may be a linear Vandermonde system of equations.

The method may further comprise the step of denoising a matrix which comprises noisy discrete Fourier transform domain (DFT) coefficients of the set of multipath channels. The step of denoising may comprise block-cadzow denoising.

The step of estimating jointly the common path support may comprise the step of using an annihilating filter to estimate jointly the common path support.

The step of estimating jointly the common path support may comprise the step of using a block ESPRIT (Estimation of Parameters via Rotation Invariance Techniques) method to estimate jointly the common path support.

The method may comprise the step of uniformly sampling the multipath channels at a rate greater than the rate of innovation of the channels. The method may comprise the step of, for each the multipath channels, uniformly sampling at a receiver a signal which was transmitted over the channel, at a rate greater than the rate of innovation of the channel. The signal may be a received signal i.e. a signal received at the receiver.

The discrete Fourier transform (DFT) of the samples of the received signals on each of the multipath channels in the set, to provide a DFT spectrum of each channel:

\hat{x}ₚ[n]=\hat{φ}[n]ŝ[n]Σₖ₌₁^{K}c_{p,k}e^{-2πnt}^{ₖ}^{/τ}+\hat{q}ₚ[n] (3)

wherein \hat{x}ₚ [n] are the samples of the received signals in the Fourier transform domain (DFT); \hat{φ}[n] is a filter chosen such as to avoid aliasing; \hat{q}ₚ [n] is noise; and K is the number of paths per channel; ŝ[n] is the transmitted signal; c_{p,k} is the path amplitude for path k of channel p; tₖ is the common support of path k; and τ is the signal period.

Some of these DFT coefficients are reserved for pilots. The proposed method supposes uniformly spaced pilots, as is conventional in Orthogonal Frequency Division Multiplexing (OFDM) communications. Contiguous pilots in the WHT domain can be set up to yield uniformly spaced pilots in the DFT domain with a power of 2 pilot interval.

The DFT coefficients corresponding to the pilots are extracted. These coefficients are equalized by the corresponding pilot sequence ŝ which may be arbitrarily fixed in communication standard and by the DFT of the filter \hat{φ} to obtain the noisy DFT coefficients of the channels

The method may comprise the step of extracting the pilot subcarriers. The method may comprise the step of extracting uniformly laid-out pilot subcarriers. The method may comprise the step of extracting the pilot subcarriers from a DFT spectrum of each channel. The method may comprise the step of extracting the pilot subcarriers from a DFT spectrum formed from samples of received signals on each of the multipath channels in the set. Preferably, DFT coefficients corresponding to the pilots may be extracted.

The step of extracting the uniformly laid-out pilot subcarriers, or coefficients corresponding to the uniformly laid-out pilot subcarriers, may comprise performing the following mathematical operation:

\hat{x}ₚ[m]←x′ₚ[mD+m₀],mD+m₀ε

[symbol]

where [symbol] is the set of pilots indices and

$${\hat{x}}_{p}^{′} [ n ] = \hat{ϕ} [ n ] \hat{s} [ n ] {\sum }_{k = 1}^{K} {c}_{p , k} {e}^{- i 2 π n {t}_{k} / τ} + {\hat{q}}_{p} [ n ]$$

for each of the multipath channels, wherein \hat{x}ₚ[n] are the samples of the received signals in the Fourier transform domain (DFT); wherein n₀ is the offset of the first pilot subcarrier; D is the number of subcarriers between pilots; \hat{φ}[n] is a filter chosen such as to avoid aliasing; \hat{q}ₚ [n] is noise; and K is the number of paths per channel; ŝ[n] is the transmitted signal; C_{p,k} is the path amplitude for path k of channel p; tₖ is the common support of path k; and τ is the signal period.

The method may further comprise the step of equalizing the received samples in the Fourier transform domain.

The step of equalizing the received samples in the Fourier transform domain may comprise making ŷₚ[m] equal to

$$\frac{{\hat{x}}_{p} [ m ]}{\hat{ϕ} [ m ] \hat{s} [ m ]} :$$

$${\hat{y}}_{p} [ m ] = \frac{{\hat{x}}_{p} [ m ]}{\hat{ϕ} [ m ] \hat{s} [ m ]}$$

The DFT coefficients corresponding to the pilots may be equalized to obtain the noisy DFT coefficients of the channels:

$${\hat{y}}_{p , m} = {\sum }_{h = 1}^{K} {c}_{h , p} {e}^{- j ( m D + {m}_{0} ) {t}_{k / τ}} + \frac{{\hat{q}}_{p} [ m D + {m}_{0} ]}{\hat{ϕ} [ m D + {m}_{0} ] \hat{s} [ m D + {m}_{0} ]} , \\ m D + {m}_{0} ε$$

wherein “D” is the interval between each pilot in frequency, and [symbol] is the index set of the pilots (i.e. the number of pilots).

The step of estimating jointly the common path support may comprise the steps of, forming a block-toeplitz matrix H^{(L}^{^{AF}}⁾ which comprises raw or denoised equalized samples, in the discrete Fourier transform domain (DFT), of received signals on each of the multipath channels; solving an annihilating filter equation H^{(L}^{^{AF}}⁾·f=O to obtain the annihilating filter coefficients (f); using the annihilating filter coefficients (f) to obtain an estimate of the sparse common support. Wherein L^{denoise} is chosen (arbitrarily) such that L^{denoise}>K^{est}; L^{AF}=K^{est}+1 and K^{est} is an estimate of the number of paths per channel.

The step of using f to obtain an estimate of the sparse common support may comprise the step of:

$${\{ {t}_{k }^{est} \}}_{k = 1 , … {K}^{est}} = - \frac{τ}{2 π D} angle ( roots ( \underline{f} ) )$$

wherein {tₖ^{est}}_{k=1, . . . K}^{est} are the common path support; K^{est} is an estimate of the number of paths per channel, and f are the annihilating filter coefficients, and D is the number of subcarriers between the pilots in the DFT domain and τ is the received signal period in seconds, on a particular channel.

The step using a block ESPRIT method to estimate jointly the common path support may comprise, choosing L^{ESPRIT} such that:

P(# [symbol] L^{ESPRIT})≧K^{est}+1, and L^{ESPRIT}≧K^{est}+1;

where # [symbol] is the number of pilots (the cardinality of set [symbol] ); building a block-toeplitz matrix H^{(L}^{^{ESPRIT}}⁾ and extracting a column subspace W of dimension K^{est} from the singular value decomposition (SVD) of H^{(L}^{^{ESPRIT}}⁾:

H^{(L}^{^{ESPRIT}}⁾=USV*→W=V_{:,1:K}_{^{est}}:

computing a matrix Ψ as the solution of:

W=Ψ W̅

such that W=W_{2:end,:} and W̅=W_{1:end-1,:} wherein, W_{2:end,:} is equal to W, without its first line, and W_{1:end-1,:} is equal to W without its last line; computing a set of eigenvalues {λₕ}_{k=1, . . . K}^{^{est}} of Ψ;
estimating jointly the common path support common path support by computing the following equation:

$${t}_{k}^{est} = \frac{- τ}{2 π D} angle ( {λ}_{k} ) , k ∈ \{ 1 , … , {K}^{est} \} .$$

The step of denoising may comprise the steps of (a) building a block matrix H^{(L}^{_{denoisel}}⁾ using samples of received signals in the discrete Fourier transform domain with L^{denoise} chosen such that the smallest dimension of H^{(L}^{_{denoise}}⁾ is greater than K^{est}, (b) reducing the block-toeplitz matrix H^{(L}^{_{denoise}}⁾ to rank K^{est} wherein K^{est} is an estimation of the number of paths in the multipath channels, (c) making the resulting matrix block-toeplitz by averaging diagonals in each block (d) repeating steps (b) and (c) until convergence to a block-toeplitz matrix of rank K^{est} occurs, (d) denoised samples, in the discrete Fourier transform domain, of received signals on each of the multipath channels are extracted from the first row and first column of each block of the converged matrix.

The step of reducing the block-toeplitz matrix H^{(L}^{^{denotse)}} to rank K^{est} may comprise carrying out truncated singular value decomposition (SVD) on the block matrix H^{(L}^{^{denotse}}⁾.

The step of using the estimate of the sparse common support to estimate multipath channels, may comprise solving P linear Vandermonde system equations, wherein P is the number of multipath channels.

The step of using the estimate of the sparse common support to estimate multipath channels comprises using the estimation of the common path support to solve the following equation:

$${\hat{y}}_{p , m} = {\sum }_{h = 1}^{K} {c}_{h , p} {e}^{- j ( m D + {m}_{0} ) {t}_{k / τ}} + \frac{{\hat{q}}_{p} [ m D + {m}_{0} ]}{\hat{ϕ} [ m D + {m}_{0} ] \hat{s} [ m D + {m}_{0} ]} , \\ m D + {m}_{0} ε$$

for each of the multipath channels, wherein \hat{x}ₚ[n] are the samples of the received signals in the Fourier transform domain (DFT); \hat{φ}[n] is a filter chosen such as to avoid aliasing; \hat{q}ₚ[n] is noise; and K is the number of paths per channel; ŝ[n] is the transmitted signal; C_{p,k} is the path amplitude for path k of channel p; tₖ is the common support of path k; and τ is the signal period.

The method may further comprise the step of dividing the estimate of the sparse common support for each of the multipath channels by a period of pilot insertion (D) in uniformly scattered discrete Fourier transform domain pilots, to estimate multipath channels in an Orthogonal Frequency Division Multiplexing (OFDM) communication system.

The method may further comprise the step of using the rank of the toeplitz matrix H^{(L}^{^{Af}}⁾ to denoise samples of signals transmitted on multipath channels.

According to a further aspect of the present invention there is provided, the use of the any one of the afore-mentioned methods to estimate DFT or WHT multiplexed channels.

The DFT or WHT multiplexed channels may be channels in OFDM or CDMA downlinks. Thus, the methods of the present invention may be applied to at least one of a OFDM or Walsh-Hadamard coded scheme.

The method according to the present invention can be applied to pilots and data multiplexed with a Walsh—Hadamard code such as in CDMA

According to a further aspect of the present invention there is provided a communication network comprising a means for implementing any one, or more, of the afore-mentioned methods.

According to a further aspect of the present invention there is provided a computer medium comprising a program which is operable to carry out any one, or more, of the afore-mentioned methods.

### BRIEF DESCRIPTION OF DRAWINGS

FIG. 1 is a flow diagram illustrating a broad overview of the steps involved in a method according to the present invention, for estimating, jointly, a set of multipath channels having a common path support;

FIG. 2 is a flow diagram illustrating, in detail, the steps involved in a method according to one embodiment of the present invention, for estimating, jointly, a set of multipath channels having a common path support;

FIG. 3 is a block diagram illustrating an Orthogonal Frequency Division Multiplexing (OFDM) communication system 1 which is comprises a means for carrying out a method according to a particular embodiment of the present invention.

### DETAILED DESCRIPTION

For example, embodiments described are directed to systems and methods of estimating multipath channels such as in a receiver system. Appendix A describes examples of such channel estimation systems and methods that may be incorporated, for example, in a receiver.

It is to be recognized that depending on the embodiment, certain acts or events of any of the methods described herein can be performed in a different sequence, may be added, merged, or left out all together (e.g., not all described acts or events are necessary for the practice of the method). Moreover, in certain embodiments, acts or events may be performed concurrently, e.g., through multi-threaded processing, interrupt processing, or multiple processors, rather than sequentially.

Those of skill will recognize that the various illustrative logical blocks, modules, circuits, and algorithm steps described in connection with the methods, systems, and apparatuses disclosed herein may be implemented as electronic hardware, computer software executed by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system Skilled artisans may implement the described functionality in varying ways for each particular application, but such implementation decisions should not be interpreted as causing a departure from the scope of the present invention.

Moreover, embodiments disclosed herein may be implemented or performed with an electronic device or circuit such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The present invention provides a method of estimating, jointly, a set of multipath channels having a common path support.

Let h=[h₁ . . . hₚ]^{T} be a vector of P exact sparse common support (SCS) channels shaped by a function φ, the complex baseband equivalent channels are:

hₚ(t)=Σₖ₌₁^{K}c_{k,p}φ(t−tₖ),C_{k,p}ΣC,tₖΣ[0τ[ (1)

The paths coefficients c_{k,p} are treated as complex random variables.

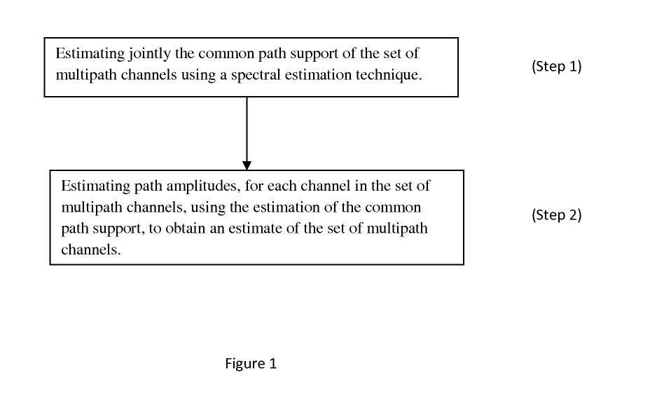

The method of the present invention will now be described with reference to FIGS. 1-3.

FIG. 1 is a flow diagram illustrating a broad overview of the steps involved in a method according to the present invention for estimating, jointly, a set of multipath channels having a common path support. Referring to FIG. 1, the method involves estimating jointly the common path support of the set of multipath channels using a spectral estimation technique (Step 1), estimating path amplitudes, for each channel in the set of multipath channels, using the estimation of the common path support, to obtain an estimate of the set of multipath channels (Step 2).

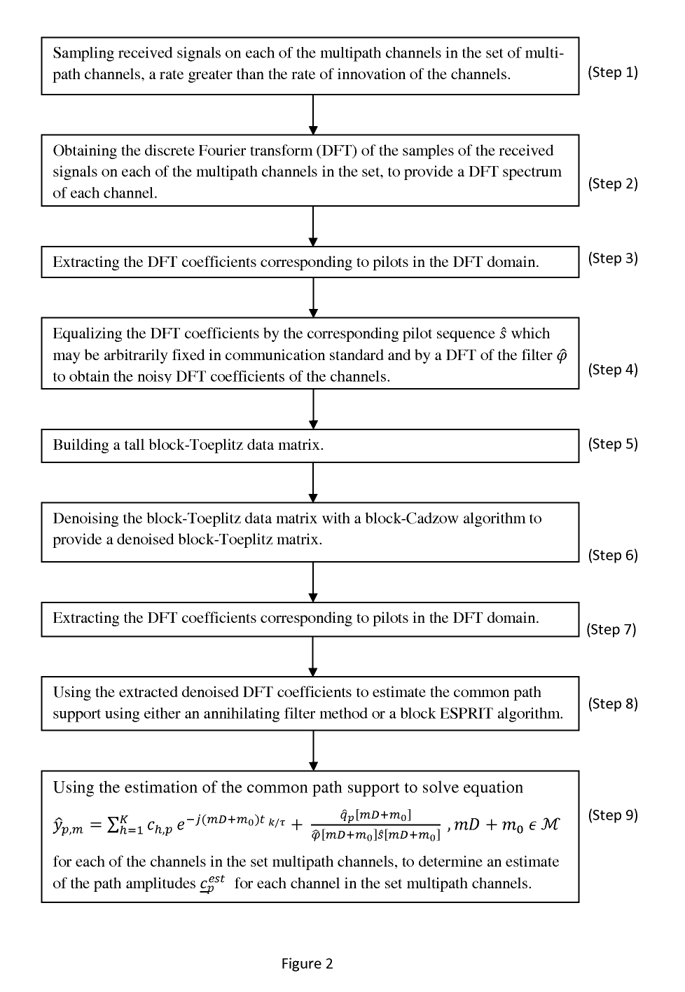

Referring now to FIG. 2; FIG. 2 is a flow diagram illustrating, in detail, the steps involved in a method according to one embodiment of the present invention, for estimating, jointly, a set of multipath channels having a common path support.

The method involves sampling received signals on each of the multipath channels in the set (Step 1). The received signals are sampled uniformly at a rate greater than the rate of innovation of the channels, after proper filtering to avoid aliasing. The samples (xₚ[n]) for each channel are in the baseband (after demodulation) and are represented as:

xₚ[n]=Σₖ₌^{k}c_{k,p}(φ*s)(nT−tₖ)+qₚ[n]nε{0, . . . , N−1}

pε{1, . . . , P} (2)

wherein φ is a filter chosen such as to avoid aliasing; T is sampling step; qₚ is noise; P is the number of channels; and K is the number of paths per channel; S is the transmitted signal. It is likely that the samples xₚ[n] will be corrupted by Additive White Gaussian Noise.

The discrete Fourier transform (DFT) of the samples of the received signals on each of the multipath channels in the set, is obtained, to provide a DFT spectrum of each channel (Step 2):

\hat{x}ₚ[n]=\hat{φ}[n]ŝ[n]Σₖ₌₁^{K}c_{p,k}e^{-i2πnt}^{ₖ}^{/τ}+\hat{q}ₚ[n] (3)

Some of these DFT coefficients are reserved for pilots. The proposed method supposes uniformly spaced pilots, as is conventional in Orthogonal Frequency Division Multiplexing (OFDM) communications. Contiguous pilots in the WHT domain can be set up to yield uniformly spaced pilots in the DFT domain with a power of 2 pilot interval.

The DFT coefficients corresponding to the pilots are extracted (Step 3). These coefficients are equalized by the corresponding pilot sequence ŝ which may be arbitrarily fixed in communication standard and by the DFT of the filter \hat{φ} to obtain the noisy DFT coefficients of the channels (Step 4):

$${\hat{y}}_{p , m} = {\sum }_{h = 1}^{K} {c}_{h , p} {e}^{- j ( m D + {m}_{0} ) {t}_{k / τ}} + \frac{{\hat{q}}_{p} [ m D + {m}_{0} ]}{\hat{ϕ} [ m D + {m}_{0} ] \hat{s} [ m D + {m}_{0} ]} , \\ m D + {m}_{0} ε \qquad ( 4 )$$

Wherein “D” is the interval between each pilot in frequency, and [symbol] is the index set of the pilots (i.e. the number of pilots).

Next, a tall block-Toeplitz data matrix (A block-Toeplitz matrix is a matrix which is constant along its diagonals) which comprises a plurality of blocks which correspond to each channel, is built (Step 5). Each block is of dimensions (# [symbol] −L)×L, wherein “# [symbol] ” is the cardinality of [symbol] (the number of pilots):

$${H}_{p}^{( L )} = [ \begin{matrix}{\hat{y}}_{p , L} & … & {\hat{y}}_{p , 1} \\ ⋮ & ⋱ & ⋮ \\ {\hat{y}}_{p , \# } & … & {\hat{y}}_{p , \# - L + 1}\end{matrix} ]$$

The blocks Hₚ^{(L)} are stacked to provide a tall block-toeplitz matrix:

$${H}^{( L )} = [ \begin{matrix}{H}_{1}^{( L )} \\ ⋮ \\ {H}_{\underline{p}}^{( L )}\end{matrix} ] \qquad ( 5 )$$

This construction is used for denoising and support estimation (with annihilating filter or block ESPRIT) with a specific value of L.

Using an estimate K^{est} of the number of paths Kin the set of multipath channels, a denoising step is carried out on the block-toeplitz matrix (5) choosing L^{denoising} such that: P (# M−L^{denoising})≧K^{est}+1 and L^{denoising}≧K^{est}+1

In this particular example the constructed block-Toeplitz matrix H^{(L}^{^{denoising}}⁾ is denoised with the block-Cadzow algorithm to provide a denoised block-Toeplitz matrix (Step 6). It will be understood that the step of denoising is entirely optional and is not an essential feature of the invention. The block-Cadzow algorithm used to denoise the block-Toeplitz matrix H^{(L}^{^{denoising}}⁾ comprises the steps of:
1: Reducing the matrix H^{(L}^{^{denoising}}⁾ to rank K by a truncated singular value decomposition (SVD).
2: Making the matrices Hₚ^{(L)}p=1 . . . P, toeplitz by averaging diagonals.
3. Repeat steps 1: and 2: until convergence to a rank K block-toeplitz matrix or for a fixed number of iterations.

The denoised DFT coefficients for each channel are extracted as the first row and first column of the corresponding denoised block of H^{(L}^{^{denoising}}⁾ (Step 7).

From the raw or denoised equalized DFT coefficients the common path support is estimated. The common path support may be estimated using either an annihilating filter method or a block ESPRIT algorithm (Step 8).

To estimate the common path support using an annihilating filter method, L^{AF} is chosen such that L^{AF}=K^{est}+1 and solve the block-toeplitz system:

H^{(L}^{^{AF}}⁾·f=O

The common path support is then computed as:

$${\{ {t}_{k}^{est} \}}_{k = 1 , … {K}^{est}} = - \frac{τ}{2 π D} angle ( roots ( \underline{f} ) )$$

wherein D is the number of subcarriers between the pilots in the DFT domain and τ is the received signal period in seconds.

To estimate the common path support using a block-ESPRIT algorithm, choose:

P(# [symbol] −L^{ESPRIT})≧K^{est}+1, and L^{ESPRIT}≧K^{est}+1;

where # [symbol] is the number of pilots (the cardinality of set [symbol] ).

Next a block-toeplitz matrix H^{(L}^{^{ESPRIT}}⁾ is built and a column subspace W of dimension K^{est} is extracted from the singular value decomposition (SVD) of H^{(L}^{^{ESPRIT}}⁾:

H^{(L}^{^{ESPRIT}}⁾=USV*→W=V_{:,1:K}_{^{est}};

Next a matrix Ψ is computed as the solution of:

W=Ψ W̅

such that W=W_{2:end,:} and W̅=W_{1:end-1,:} wherein, W_{2:end,:} is equal to W, without its first line, and W_{1:end-1,:} is equal to W without its last line.

A set of eigenvalues {λₖ}_{k=1, . . . K}_{^{est}} of Ψ is then computed; followed by the step of estimating jointly the common path support common path support by computing the following equation:

$${t}_{k}^{est} = \frac{- τ}{2 π D} angle ( {λ}_{k} ) , k ∈ \{ 1 , … , {K}^{est} \} .$$

Using the computed common path support the path amplitudes may be estimated independently for each channel.

An estimate of the path amplitudes cₚ^{est} for each channel in the set multipath channels can be determined, individually, using the estimation of the common path support to solve equation (4) for each of the channels in the set of multipath channels (Step 9). Thus, an estimate of the path amplitudes cₚ^{est} for each channel is obtained separately. Solving equation (4) for P channels provides, for p=1, . . . , P:

$$[ \begin{matrix}{e}^{- j 2 π {m}_{0} {t}_{1}^{est} / τ} & … & {e}^{- j 2 π {m}_{0} {t}_{K}^{est} / τ} \\ ⋮ & ⋱ & ⋮ \\ {e}^{- j 2 π ( ( \# - 1 ) D + {m}_{0} ) {t}_{1}^{est} / τ} & … & {e}^{- j 2 π ( ( \# - 1 ) D + {m}_{0} ) {t}_{K}^{est} / τ}\end{matrix} ] {\underline{c}}_{p}^{est} = [ \begin{matrix}{\hat{y}}_{p , 1} \\ ⋮ \\ ⋮ \\ {\hat{y}}_{p , \# }\end{matrix} ]$$

Such that cₚ^{est}=[c_{p,1}^{est} . . . c_{p,k}^{est}]^{T} the vector of estimated path amplitudes for the p^{th} channel.

The sets {t^{est}}_{k=1, . . . K}_{^{est}} and {cₚ^{estx}}_{p=1, . . . , P} provides a complete and concise description of the channels at any frequency. It can be used, among other, to equalize the channel at data carrying frequencies or it can be fed back to the transmitter for transmit beam-forming.

Advantageously, using the sparse common support property to estimate multipath channels, the total number of parameters to be estimated can be reduced, thereby improving the estimate and/or reducing the pilot overhead.

An embodiment of a method according to the present invention may be implemented using the following algorithm:

Algorithm: sparse common support finite rate of Innovation channel
estimation

Require: An estimate on the number of effective paths K^{est}, and for each
channel a vector ŷₚ of # M noisy channel DFT coefficients as in equation
(4)
Ensure: Support estimate {tₖ^{est}}_{k=1. . .K}^{est}
if denoising

| | |
|---|---|
| 1: | build H^{(L}^{^{denoising}}⁾ according to (5) |
| 2: | H^{(L}^{^{denoising}}⁾ ← Block-Cadzow (H^{(L}^{^{denoising}}⁾, K^{est}). |
| 3: | Update ŷₚ with the first row and column of the denoised block Hₚ^{(M)}. |

end if
in annihilating filter

| | |
|---|---|
| 4: | Build H^{(K}^{^{est}}⁺¹⁾ according to (5) |
| 5: | Solve the annihilating filter equation (6) to get f |
| 6: | ${\{ {t}_{k}^{est} \}}_{k = 1. . . {k}^{est}} ← - \frac{τ}{2 π D} angle ( roots ( f ) ) .$ |

else if block ESPRIT

| | |
|---|---|
| 7: | Build H^{(L}^{^{ESPRIT}}⁾ according to (5) |
| 8: | H^{(L}^{^{ESPRIT}}⁾ = USV^{*} → W = V_{:,1:K}^{est} |
| 9: | Solve W = Ψ W̅, such that W = W_{2:end,:} and W̅ = W_{1:end-1,:} |
| 10: | ${\{ {t}_{k}^{est} \}}_{k = 1. . . {k}^{est}} ← \frac{- τ}{2 π D} angle ( eig ( Ψ ) ) , where eig ( Ψ ) are the$ $eigenvalues of Ψ$ |

end if

| | |
|---|---|
| 10: | Estimate {c_{k,p}} solving P linear Vandermonde system equations (3) |
| | for each channel. |

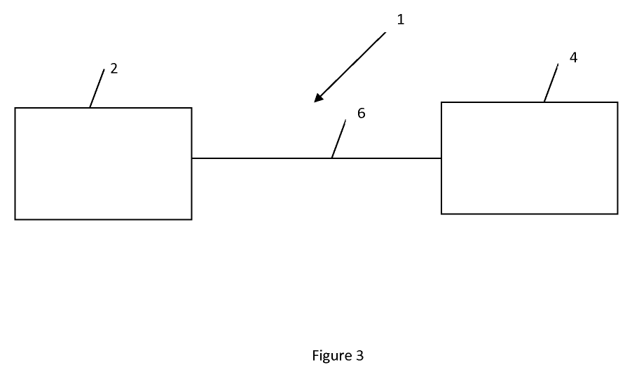

FIG. 3 is a block diagram illustrating an Orthogonal Frequency Division Multiplexing (OFDM) communication system 1 which is comprises a means for carrying out a method according to a particular embodiment of the present invention. The Orthogonal Frequency Division Multiplexing (OFDM) communication system 1 comprises a transmitter 2 and receiver 4 which are arranged in operable communication via a set of multipath channels 6 having a common support. Signals are transmitted by the transmitter 2 and are communicated over the set of multipath channels 6 so that they can be received at the receiver 4. As in conventional in Orthogonal Frequency Division Multiplexing (OFDM) communication systems the Orthogonal Frequency Division Multiplexing (OFDM) communication system 1 comprises uniformly spaced pilots (i.e. uniformly scattered discrete Fourier transform domain pilots). In the Orthogonal Frequency Division Multiplexing (OFDM) communication system 1 the uniformly spaced pilots are each spaced by a period of pilot insertion (D).

The receiver 4 comprises a means to estimate jointly the common path support of the set of multipath channels 6 by; forming a toeplitz matrix H^{(L}^{^{Af}}⁾ which comprises samples, in the discrete Fourier transform domain (DFT), of received signals on each of the multipath channels in the set of multipath channels 6; denoising the toeplitz matrix H^{(L}^{^{Af}}⁾ using block-cadzow denoising; solving an annihilating filter equation H^{(L}^{^{Af}}⁾. f=O to obtain the annihilating filter coefficients (f); using the annihilating filter coefficients (f) to obtain an estimate of the sparse common support, by carrying out the step of:

$${\{ {t}_{h}^{est} \}}_{h = 1 , … {k}^{est}} = - \frac{τ}{2 τ D} angle ( roots ( \underline{f} ) )$$

wherein {tₖ^{est}}k is the common path support; k^{est} is an estimate of the number of paths per channel, and f are the annihilating filter coefficients, and D is the distance between the pilots in the DFT domain and τ is the received signal period in seconds, on a particular channel.

The receiver 4 is configured to estimate the multipath channels by using the estimation of the common path support to solve the following equation:

$${\hat{y}}_{p , m} = {\sum }_{h = 1}^{K} {c}_{h , p} {e}^{- j ( m D + {m}_{0} ) {t}_{k / τ}} + \frac{{\hat{q}}_{p} [ m D + {m}_{0} ]}{\hat{ϕ} [ m D + {m}_{0} ] \hat{s} [ m D + {m}_{0} ]} , \\ m D + {m}_{0} ε$$

for each of the channels in the set of multipath channels 6, wherein \hat{x}ₚ[n] are the samples of the received signals in the Fourier transform domain (DFT); \hat{φ}[n] is a filter chosen such as to avoid aliasing; \hat{q}ₚ[n] is noise; and K is the number of paths per channel; ŝ[n] is the transmitted signal; c_{p,k} is the path amplitude for path k of channel p; tₖ is the common support of path k; and τ is the signal period. The receiver 4 is configured to divide the estimate of the sparse common support for each of the channels in the set of multipath channels 6, by a period of pilot insertion (D) in the uniformly scattered discrete Fourier transform domain pilots, to estimate multipath channels in an Orthogonal Frequency Division Multiplexing (OFDM) communication system 1.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment. For example, it will be understood that the method according to the present invention applies also for pilots and data multiplexed with a Walsh—Hadamard code such as in CDMA.

1. A method of estimating, jointly, a set of multipath channels having a common path support, the method comprising:
estimating jointly the common path support of the set of multipath channels using a spectral estimation technique; and
estimating path amplitudes, for each channel in the set of multipath channels, using the estimation of the common path support, to obtain an estimate of the set of multipath channels.

2. The method according to claim 1 wherein estimating path amplitudes, for each channel in the set of multipath channels, using the estimation of the common path support, comprises solving a linear system of equations.

3. The method according to claim 1 further comprising the step of denoising a matrix which comprises noisy discrete Fourier transform domain (DFT) coefficients of the set of multipath channels using block-cadzow denoising.

4. The method according to claim 1, wherein estimating jointly the common path support comprises using an annihilating filter to estimate jointly the common path support.

5. The method according to claim 1, wherein estimating jointly the common path support comprises using a block-ESPRIT method to estimate jointly the common path support.

6. The method according to claim 1 wherein estimating jointly the common path support comprises the steps of, forming a toeplitz matrix H^{(L}^{^{Af}}⁾ which comprises samples, in the discrete Fourier transform domain (DFT), of received signals on each of the multipath channels; solving an annihilating filter equation H^{(L}^{^{Af}}⁾·f=O to obtain the annihilating filter coefficients (f); using the annihilating filter coefficients (f) to obtain an estimate of the sparse common support, wherein L^{AF}=K^{est}+1 and K^{est} is an estimate of the number of paths per channel.

7. The method according to claim 6 wherein using f to obtain an estimate of the sparse common support comprises:
$${\{ {t}_{h}^{est} \}}_{h = 1 , … {k}^{est}} = - \frac{τ}{2 τ D} angle ( roots ( \underline{f} ) )$$
wherein {tₖ^{est}}k is the common path support; k^{est} is an estimate of the number of paths per channel, and f are the annihilating filter coefficients, and D is the distance between the pilots in the DFT domain and τ is the received signal period in seconds, on a particular channel.

8. The method according to claim 6 comprising: (a) building a block matrix H^{(L}^{^{denoise}}⁾ using samples of received signals in the discrete Fourier transform domain with L^{denoise} chosen such that the smallest dimension of H^{(L}^{^{denoise}}⁾ is greater than K^{est}, (b) reducing the block-toeplitz matrix H^{(L}^{^{denoise}}⁾ to rank K^{est} wherein K^{est} is an estimation of the number of paths in the multipath channels, (c) generating the resulting matrix block-toeplitz by averaging diagonals in each block (d) repeating steps (b) and (c) until convergence to a block-toeplitz matrix of rank K^{est} occurs, (d) extracting from the first row and first column of each block of the converged matrix, denoised samples, in the discrete Fourier transform domain, of received signals.

9. The method according to claim 5 wherein an ESPRIT method to estimate jointly the common path support comprises, choosing L^{ESPRIT} such that:
P(# [symbol] −L^{ESPRIT})≧K^{est}+1, and L^{ESPRIT}≧K^{est}+1;
where # [symbol] is the number of pilots (the cardinality of set [symbol] );
building a block-toeplitz matrix H^{(L}^{^{ESPRIT}}⁾ and extracting a column subspace W of dimension K^{est} from the singular value decomposition (SVD) of H^{(L}^{^{ESPRIT}}⁾:
H^{(L}^{^{ESPRIT}}⁾=USV*→W=V_{:,1:K}_{^{est}};
computing a matrix Ψ as the solution of:
W=Ψ W̅
such that W=W_{2:end,1} and W̅=W_{1:end-1,;} wherein W_{2:end,;} is equal to W, without its first line, and W_{1:end-1,:} is equal to W without its last line;
computing a set of eigenvalues {λₕ}_{k=1, . . . K}_{^{est}} of Ψ;
estimating jointly the common path support common path support by computing the following equation:
$${t}_{k}^{est} = \frac{- τ}{2 π D} angle ( {λ}_{k} ) , k ∈ \{ 1 , … , {K}^{est} \} .$$

10. The method according to claim 1 wherein using the estimate of the sparse common support to estimate multipath channels comprises using the estimation of the common path support to solve the following equation:
$${\hat{y}}_{p , m} = {\sum }_{h = 1}^{K} {c}_{h , p} {e}^{- j ( m D + {m}_{0} ) {t}_{k / τ}} + \frac{{\hat{q}}_{p} [ m D + {m}_{0} ]}{\hat{ϕ} [ m D + {m}_{0} ] \hat{s} [ m D + {m}_{0} ]} , \\ m D + {m}_{0} ε$$
for each of the multipath channels, wherein \hat{x}ₚ[n] are the samples of the received signals in the Fourier transform domain (DFT); \hat{φ}[n] is a filter chosen such as to avoid aliasing; \hat{q}ₚ[n] is noise; and K is the number of paths per channel; ŝ[n] is the transmitted signal; c_{p,k} is the path amplitude for path k of channel p; tₖ is the common support of path k; and τ is the signal period.

11. The method according to claim 1 further comprising dividing the estimate of the sparse common support for each of the multipath channels by a period of pilot insertion (D) in uniformly scattered discrete Fourier transform domain pilots, to estimate multipath channels in an Orthogonal Frequency Division Multiplexing (OFDM) communication system.

12. The method of claim 1, wherein estimating the set of multipath channels comprises an estimating DFT or WHT multiplexed channels.

13. (canceled)

14. (canceled)

15. An communications device, comprising:
a receiver configured to receive a set of multipath channels; and
a processor configured to estimate, jointly, the set of multipath channels having a common path support, wherein to estimate the processor is configured to:
estimate jointly the common path support of the set of multipath channels using a spectral estimation technique; and
estimate path amplitudes, for each channel in the set of multipath channels, using the estimation of the common path support, to obtain an estimate of the set of multipath channels.

16. The device according to claim 15 wherein to estimate path amplitudes, for each channel in the set of multipath channels, using the estimation of the common path support, comprises solving a linear system of equations.

17. The device according to claim 15, wherein the processor is further configured to denoise a matrix which comprises noisy discrete Fourier transform domain (DFT) coefficients of the set of multipath channels using block-cadzow denoising.

18. The device according to claim 15, wherein to estimate jointly the common path support comprises using an annihilating filter to estimate jointly the common path support.

19. The device according to claim 15, wherein to estimate jointly the common path support comprises using a block-ESPRIT method to estimate jointly the common path support.

20. The device according to claim 15, wherein to estimate jointly the common path support comprises the steps of, forming a toeplitz matrix H^{(L}^{^{Af}}⁾ which comprises samples, in the discrete Fourier transform domain (DFT), of received signals on each of the multipath channels; solving an annihilating filter equation H^{(L}^{^{Af}}⁾·f=O to obtain the annihilating filter coefficients (f); using the annihilating filter coefficients (f) to obtain an estimate of the sparse common support, wherein L^{AF}=K^{est}+1 and K^{est} is an estimate of the number of paths per channel.

21. The device according to claim 15, wherein using f to obtain an estimate of the sparse common support comprises:
$${\{ {t}_{h}^{est} \}}_{h = 1 , … {k}^{est}} = - \frac{τ}{2 τ D} angle ( roots ( \underline{f} ) )$$
wherein {tₖ^{est}}k is the common path support; k^{est} is an estimate of the number of paths per channel, and f are the annihilating filter coefficients, and D is the distance between the pilots in the DFT domain and τ is the received signal period in seconds, on a particular channel.

22. The device according to claim 15, wherein the processor is further configured to: (a) build a block matrix H^{(L}^{^{denoise}}⁾ using samples of received signals in the discrete Fourier transform domain with L^{denoise} chosen such that the smallest dimension of H^{(L}^{^{denoise}}⁾ is greater than K^{est}, (b) reduce the block-toeplitz matrix H^{(L}^{^{denoise}}⁾ to rank K^{est} wherein K^{est} is an estimation of the number of paths in the multipath channels, (c) generate the resulting matrix block-toeplitz by averaging diagonals in each block (d) repeating steps (b) and (c) until convergence to a block-toeplitz matrix of rank K^{est} occurs, (d) extract from the first row and first column of each block of the converged matrix, denoised samples, in the discrete Fourier transform domain, of received signals.

23. The device according to claim 15, wherein an ESPRIT method to estimate jointly the common path support comprises, choosing L^{ESPRIT} such that:
P(# [symbol] −L^{ESPRIT})≧K^{est}+1, and L^{ESPRIT}≧K^{est}+1;
where # [symbol] is the number of pilots (the cardinality of set [symbol] ); building a block-toeplitz matrix H^{(L}^{^{denoise}}⁾ and extracting a column subspace W of dimension K^{est} from the singular value decomposition (SVD) of H^{(L}^{^{ESPRIT}}⁾:
H^{(L}^{^{ESPRIT}}⁾=USV*→W=V_{:,1:K}_{^{est}};
computing a matrix Ψ as the solution of:
W=Ψ W̅
such that W=W_{2:end,:} and W̅=W_{1:end-1},: wherein, W_{2:end,:} is equal to W, without its first line, and W_{1:end-1,:} is equal to W without its last line;
computing a set of eigenvalues {λₕ}_{k-1, . . . K}_{^{est}} of Ψ;
estimating jointly the common path support common path support by computing the following equation:
$${t}_{k}^{est} = \frac{- τ}{2 π D} angle ( {λ}_{k} ) , k ∈ \{ 1 , … , {K}^{est} \} .$$

24. The device according to claim 15, wherein using the estimate of the sparse common support to estimate multipath channels comprises using the estimation of the common path support to solve the following equation:
$${\hat{y}}_{p , m} = {\sum }_{h = 1}^{K} {c}_{h , p} {e}^{- j ( m D + {m}_{0} ) {t}_{k / τ}} + \frac{{\hat{q}}_{p} [ m D + {m}_{0} ]}{\hat{ϕ} [ m D + {m}_{0} ] \hat{s} [ m D + {m}_{0} ]} , \\ m D + {m}_{0} ε$$
for each of the multipath channels, wherein \hat{x}ₚ[n] are the samples of the received signals in the Fourier transform domain (DFT); \hat{φ}[n] is a filter chosen such as to avoid aliasing; \hat{q}ₚ[n] is noise; and K is the number of paths per channel; ŝ[n] is the transmitted signal; c_{p,k} is the path amplitude for path k of channel p; tₖ is the common support of path k; and τ is the signal period.

25. The device according to claim 15, wherein the processor is further configured to divide the estimate of the sparse common support for each of the multipath channels by a period of pilot insertion (D) in uniformly scattered discrete Fourier transform domain pilots, to estimate multipath channels in an Orthogonal Frequency Division Multiplexing (OFDM) communication system.

26. The device according to claim 15, wherein the processor is configured to estimate the set of multipath channels so as to estimate DFT or WHT multiplexed channels.

27. A non-transitory computer readable medium having stored thereon instructions that when executed by a processor associated with a receiver cause the processor to:
estimate jointly the common path support of the set of multipath channels using a spectral estimation technique; and
estimate path amplitudes, for each channel in the set of multipath channels, using the estimation of the common path support, to obtain an estimate of the set of multipath channels.

28. The medium according to claim 27 wherein to estimate path amplitudes, for each channel in the set of multipath channels, using the estimation of the common path support, comprises solving a linear system of equations.

29. The medium according to claim 27, wherein the processor is further cause to denoise a matrix which comprises noisy discrete Fourier transform domain (DFT) coefficients of the set of multipath channels using block-cadzow denoising.

30. The medium according to claim 27, wherein to estimate jointly the common path support comprises using an annihilating filter to estimate jointly the common path support.

31. The medium according to claim 27, wherein to estimate jointly the common path support comprises using a block-ESPRIT method to estimate jointly the common path support.

32. The medium according to claim 27, wherein to estimate jointly the common path support comprises the steps of, forming a toeplitz matrix H^{L}^{^{Af}}⁾ which comprises samples, in the discrete Fourier transform domain (DFT), of received signals on each of the multipath channels; solving an annihilating filter equation H^{(L}^{^{Af}}⁾·f=O to obtain the annihilating filter coefficients (f); using the annihilating filter coefficients (f) to obtain an estimate of the sparse common support, wherein L^{AF}=K^{est}+1 and K^{est} is an estimate of the number of paths per channel.

33. The medium according to claim 27, wherein using f to obtain an estimate of the sparse common support comprises:
$${\{ {t}_{h}^{est} \}}_{h = 1 , … {k}^{est}} = - \frac{τ}{2 τ D} angle ( roots ( \underline{f} ) )$$
wherein {tₖ^{est}}k is the common path support; k^{est} is an estimate of the number of paths per channel, and f are the annihilating filter coefficients, and D is the distance between the pilots in the DFT domain and τ is the received signal period in seconds, on a particular channel.

34. The medium according to claim 27, wherein the processor is further caused to: (a) build a block matrix H^{(L}^{^{denoise}}⁾ using samples of received signals in the discrete Fourier transform domain with (L^{denoise}) chosen such that the smallest dimension of H^{(L}^{^{denoise}}⁾ is greater than K^{est}, (b) reduce the block-toeplitz matrix H^{(L}^{^{denoise}}⁾ to rank K^{est} wherein K^{est} is an estimation of the number of paths in the multipath channels, (c) generate the resulting matrix block-toeplitz by averaging diagonals in each block (d) repeating steps (b) and (c) until convergence to a block-toeplitz matrix of rank K^{est} occurs, (d) extract from the first row and first column of each block of the converged matrix, denoised samples, in the discrete Fourier transform domain, of received signals.

35. The medium according to claim 27, wherein an ESPRIT method to estimate jointly the common path support comprises, choosing L^{ESPRIT} such that:
P(# [symbol] −L^{ESPRIT})≧K^{est}+1, and L^{ESPRIT}≧K^{est}+1;
where # [symbol] Pr is the number of pilots (the cardinality of set [symbol] );
building a block-toeplitz matrix H^{(L}^{^{ESPRIT}}⁾ and extracting a column subspace W of dimension K^{est} from the singular value decomposition (SVD) of H^{(L}^{^{ESPRIT}}⁾:
H^{(L}^{^{ESPRIT}}⁾=USV*→W=V_{:,1:K}_{^{est}};
computing a matrix Ψ as the solution of:
W=Ψ W̅
such that W=W_{2:end,:} and W̅=W_{1:end-1,:} wherein, W_{2:end,:} is equal to W, without its first line, and W_{1:end-1,:} is equal to W without its last line;
computing a set of eigenvalues {λₙ}_{k=1, . . . , K}_{^{est}} of Ψ;
estimating jointly the common path support common path support by computing the following equation:
$${t}_{k}^{est} = \frac{- τ}{2 π D} angle ( {λ}_{k} ) , k ∈ \{ 1 , … , {K}^{est} \} .$$

36. The medium according to claim 27, wherein using the estimate of the sparse common support to estimate multipath channels comprises using the estimation of the common path support to solve the following equation:
$${\hat{y}}_{p , m} = {\sum }_{h = 1}^{K} {c}_{h , p} {e}^{- j ( m D + {m}_{0} ) {t}_{k / τ}} + \frac{{\hat{q}}_{p} [ m D + {m}_{0} ]}{\hat{ϕ} [ m D + {m}_{0} ] \hat{s} [ m D + {m}_{0} ]} , \\ m D + {m}_{0} ε$$
for each of the multipath channels, wherein \hat{x}ₚ[n] are the samples of the received signals in the Fourier transform domain (DFT); \hat{φ}[n] is a filter chosen such as to avoid aliasing; \hat{q}ₚ[n] is noise; and K is the number of paths per channel; ŝ[n] is the transmitted signal; c_{p,k} is the path amplitude for path k of channel p; tₖ is the common support of path k; and τ is the signal period.

37. The medium according to claim 27, wherein the processor is further caused to divide the estimate of the sparse common support for each of the multipath channels by a period of pilot insertion (D) in uniformly scattered discrete Fourier transform domain pilots, to estimate multipath channels in an Orthogonal Frequency Division Multiplexing (OFDM) communication system.

38. The medium according to claim 27, wherein the processor is further caused to estimate the set of multipath channels so as to estimate DFT or WHT multiplexed channels.

39. An communications device, comprising:
means for receiving a set of multipath channels; and
means for estimating, jointly, the set of multipath channels having a common path support, wherein the estimating means is configured to:
estimate jointly the common path support of the set of multipath channels using a spectral estimation technique; and
estimate path amplitudes, for each channel in the set of multipath channels, using the estimation of the common path support, to obtain an estimate of the set of multipath channels.
